(19) United States
(12) Patent Application Publication
(10) Pub. No.: US 2025/0324385 A1
(43) Pub. Date: Oct. 16, 2025

(54) METHODS AND APPARATUSES FOR RAT-DEPENDENT POSITIONING INTEGRITY

(71) Applicant: LENOVO (BEIJING) LIMITED, Beijing (CN)

(72) Inventors: Jie HU, Beijing (CN); Jing HAN, Beijing (CN); Haiming WANG, Beijing (CN); Lianhai WU, Beijing (CN); Min XU, Beijing (CN)

(21) Appl. No.: 18/855,587

(22) PCT Filed: May 10, 2022
(86) PCT No.: PCT/CN2022/092004

§ 371 Date: Oct. 9, 2024

(51) Int. Cl. H04W 64/00; H04W 8/22

(52) U.S. Cl. CPC H04W 64/00; H04W 8/22

(57) ABSTRACT

Embodiments of the present disclosure relate to methods and apparatuses for radio access technology (RAT) dependent positioning integrity. According to an embodiment of the present disclosure, a user equipment (UE) may include: a receiver configured to receive a request message to request first capability information for RAT-dependent positioning integrity from a base station (BS) or a location management function (LMF); a transmitter configured to transmit a response message including the first capability information to the BS or the LMF; and a processor coupled to the receiver and the transmitter.

### TECHNICAL FIELD

Embodiments of the present application generally relate to wireless communication technology, and especially to methods and apparatuses for radio access technology (RAT) dependent positioning integrity.

### BACKGROUND

Positioning integrity refers to a measure of trust in an accuracy of position-related data provide by a positioning system and an ability to provide timely and valid warnings to a location service (LCS) client when the positioning system does not fulfil a condition for an intended operation. The concepts of positioning integrity have already been introduced and supported for global navigation satellite system (GNSS) positioning in 3rd generation partnership project (3GPP) Rel-17. However, details regarding integrity support for RAT-dependent positioning have not been studied yet.

### SUMMARY OF THE APPLICATION

Embodiments of the present application at least provide technical solutions for RAT-dependent positioning integrity.

According to some embodiments of the present application, a user equipment (UE) may include a receiver configured to receive a request message to request first capability information for RAT-dependent positioning integrity from a base station (BS) or a location management function (LMF); a transmitter configured to transmit a response message including the first capability information to the BS or the LMF; and a processor coupled to the receiver and the transmitter.

In some embodiments of the present application, the first capability information includes one or more sets of information, wherein each set of information is associated with a RAT-dependent positioning method and includes at least one of: an indication indicating whether the UE has a RAT-dependent integrity capability for the RAT-dependent positioning method; or an integrity level for the RAT-dependent positioning method supported by the UE.

In some embodiments of the present application, the receiver is further configured to receive second capability information for RAT-dependent positioning integrity from the LMF, wherein the second capability information includes one or more sets of information, wherein each set of information is associated with a RAT-dependent positioning method and includes at least one of: an indication indicating whether the BS has a RAT-dependent integrity capability for the RAT-dependent positioning method; or an integrity level for the RAT-dependent positioning method supported by the BS.

In some embodiments of the present application, the transmitter is further configured to transmit at least one integrity key performance indicator (KPI) to the BS and to the LMF.

In some embodiments of the present application, the receiver is further configured to receive, from the LMF, RAT-dependent positioning integrity assistance information including least one of: RAT-dependent positioning assistance data with a quality indicator; an integrity service parameter indicating a range of integrity risks (IRs) for which the RAT-dependent positioning assistance data is valid; or sounding reference signal (SRS) measurement result(s) with a quality indicator.

In some embodiments of the present application, the receiver is further configured to receive, from the BS, RAT-dependent positioning integrity assistance information including SRS measurement result(s) with a quality indicator.

In some embodiments of the present application, the receiver is further configured to receive, from the BS or the LMF, at least one of: severity level(s) of detected integrity feared event(s); integrity result(s); or an integrity alert.

In some embodiments of the present application, the transmitter is further configured to transmit, to the LMF, RAT-dependent positioning integrity assistance information including at least one of: an integrity service parameter indicating a range of IRs for which RAT-dependent positioning assistance data is valid; positioning reference signal (PRS) measurement result(s) with a quality indicator; or information related to the UE.

In some embodiments of the present application, the processor is configured to: detect integrity feared event(s); and evaluate severity level(s) of the integrity feared event(s) or calculate integrity result(s); and the transmitter is further configured to transmit, to the LMF, at least one of the severity level(s) of the integrity feared event(s) or the integrity result(s).

In some embodiments of the present application, the transmitter is further configured to transmit the integrity result(s) to the LMF in response to that the integrity result(s) reaches (reach) a pre-defined threshold.

In some embodiments of the present application, the transmitter is further configured to transmit an integrity alert to the LMF in response to that detected integrity information is within a predefined threshold range.

In some embodiments of the present application, the RAT-dependent positioning integrity assistance information is transmitted to the LMF periodically.

In some embodiments of the present application, the at least one of the severity level(s) of the integrity feared event(s) or the integrity result(s) is transmitted to the LMF periodically.

According to some other embodiments of the present application, a BS may include: a receiver configured to receive a request message to request first capability information for RAT-dependent positioning integrity from an LMF; a transmitter configured to transmit a response message including the first capability information to the LMF; and a processor coupled to the receiver and the transmitter.

In some embodiments of the present application, the first capability information includes one or more sets of information, wherein each set of information is associated with a RAT-dependent positioning method and includes at least one of: an indication indicating whether the BS has a RAT-dependent integrity capability for the RAT-dependent positioning method; or an integrity level for the RAT-dependent positioning method supported by the BS.

In some embodiments of the present application, the receiver is further configured to receive second capability information for RAT-dependent positioning integrity, wherein the second capability information includes one or more sets of information, wherein each set of information is associated with a RAT-dependent positioning method and includes at least one of: an indication indicating whether a UE has a RAT-dependent integrity capability for the RAT-dependent positioning method; or an integrity level for the RAT-dependent positioning method supported by the UE.

In some embodiments of the present application, the second capability information is received from the UE, and the transmitter is further configured to transmit the second capability information to the LMF.

In some embodiments of the present application, the receiver is further configured to receive a first request message to request the second capability information from the LMF, and the transmitter is further configured to transmit a second request message to request the second capability information to the UE.

In some embodiments of the present application, the second capability information is received from the LMF.

In some embodiments of the present application, the receiver is further configured to receive at least one integrity KPI from the LMF.

In some embodiments of the present application, the receiver is further configured to receive at least one integrity KPI from the UE.

In some embodiments of the present application, the transmitter is further configured to transmit RAT-dependent positioning integrity assistance information to the UE or to the LMF, wherein the RAT-dependent positioning integrity assistance information includes SRS measurement result(s) with a quality indicator.

In some embodiments of the present application, the RAT-dependent positioning integrity assistance information is transmitted to the UE or to the LMF once the BS generates the SRS measurement result(s) or in response to the SRS measurement result(s) reach (reaches) a pre-defined threshold.

In some embodiments of the present application, the processor is configured to: detect integrity feared event(s); and evaluate severity level(s) of the integrity feared event(s) or calculate integrity result(s); and the transmitter is further configured to transmit, to the UE or to the LMF, at least one of the severity level(s) of the integrity feared event(s) or the integrity result(s).

In some embodiments of the present application, the transmitter is further configured to transmit the integrity result(s) to the UE or to the LMF in response to that the integrity result(s) reaches (reach) a pre-defined threshold.

In some embodiments of the present application, the transmitter is further configured to transmit an integrity alert to the UE or to the LMF in response to that detected integrity information is within a predefined threshold range.

In some embodiments of the present application, the RAT-dependent positioning integrity assistance information is transmitted periodically.

In some embodiments of the present application, the at least one of the severity level(s) of the integrity feared event(s) or the integrity result(s) is transmitted to the UE or the LMF periodically.

According to some embodiments of the present application, a network entity may include: a transmitter configured to transmit a request message to request first capability information for RAT-dependent positioning integrity to a UE or a BS; a receiver configured to receive a response message including the first capability information from the UE or the BS; and a processor coupled to the receiver and the transmitter.

In some embodiments of the present application, the first capability information includes one or more sets of information, wherein each set of information is associated with a RAT-dependent positioning method and includes at least one of: an indication indicating whether the UE has a RAT-dependent integrity capability for the RAT-dependent positioning method; or an integrity level for the RAT-dependent positioning method supported by the UE.

In some embodiments of the present application, the request message transmitted to the UE indicates that the UE reports the first capability information to the BS.

In some embodiments of the present application, the transmitter is further configured to transmit the first capability information received from the UE to the BS.

In some embodiments of the present application, the transmitter is further configured to transmit a request message to request second capability information for RAT-dependent positioning integrity to the BS; and the receiver is further configured to receive a response message including the second capability information from the BS.

In some embodiments of the present application, the second capability information includes one or more sets of information, wherein each set of information is associated with a RAT-dependent positioning method and includes at least one of: an indication indicating whether the BS has a RAT-dependent integrity capability for the RAT-dependent positioning method; or an integrity level for the RAT-dependent positioning method supported by the BS.

In some embodiments of the present application, the transmitter is further configured to transmit the second capability information to the UE.

In some embodiments of the present application, the transmitter is further configured to transmit at least one integrity KPI to the BS and to the UE.

In some embodiments of the present application, the transmitter is further configured to transmit, to the UE, RAT-dependent positioning integrity assistance information including least one of: RAT-dependent positioning assistance data with a quality indicator; an integrity service parameter indicating a range of IRs for which the RAT-dependent positioning assistance data is valid; or SRS measurement result(s) with a quality indicator.

In some embodiments of the present application, the receiver is further configured to receive RAT-dependent positioning integrity assistance information from the BS, wherein the RAT-dependent positioning integrity assistance information includes SRS measurement result(s) with a quality indicator.

In some embodiments of the present application, the receiver is further configured to receive, from the BS, at least one of: severity level(s) of detected integrity feared event(s); integrity result(s); or an integrity alert.

In some embodiments of the present application, the processor is configured to: detect integrity feared event(s); and evaluate severity level(s) of the integrity feared event(s) or calculate integrity result(s); and the transmitter is further configured to transmit, to the UE, at least one of the severity level(s) of the integrity feared event(s) or the integrity result(s).

In some embodiments of the present application, the transmitter is further configured to transmit the integrity result(s) to the UE in response to that the integrity result(s) reaches (reach) a pre-defined threshold.

In some embodiments of the present application, the transmitter is further configured to transmit an integrity alert to the UE in response to that detected integrity information is within a predefined threshold range.

In some embodiments of the present application, the RAT-dependent positioning integrity assistance information is transmitted to the UE periodically.

In some embodiments of the present application, the at least one of the severity level(s) of the integrity feared event(s) or the integrity result(s) is transmitted to the UE periodically.

In some embodiments of the present application, the receiver is further configured to receive, from the UE, RAT-dependent positioning integrity assistance information including least one of: an integrity service parameter indicating a range of IRs for which RAT-dependent positioning assistance data is valid; PRS measurement result(s) with a quality indicator; or information related to the UE.

In some embodiments of the present application, the receiver is further configured to receive, from the UE, at least one of: severity level(s) of detected integrity feared event(s); integrity result(s); or an integrity alert.

According to some other embodiments of the present application, a method performed by a UE may include: receiving a request message to request first capability information for RAT-dependent positioning integrity from a BS or an LMF; and transmitting a response message including the first capability information to the BS or the LMF.

According to some other embodiments of the present application, a method performed by a BS may include: receiving a request message to request first capability information for RAT-dependent positioning integrity from an LMF; and transmitting a response message including the first capability information to the LMF.

According to some other embodiments of the present application, a method performed by a network entity may include: transmitting a request message to request first capability information for RAT-dependent positioning integrity to a UE or a BS; and receiving a response message including the first capability information from the UE or the BS.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates exemplary relationships between a protection level (PL) and key performance indicators (KPIs) for positioning integrity according to some embodiments of the present application;

FIG. 3 illustrates an exemplary UE's capability information transfer procedure according to some embodiments of the present application;

FIG. 4 illustrates another exemplary UE's capability information transfer procedure according to some embodiments of the present application;

FIG. 5 illustrates yet another exemplary UE's capability information transfer procedure according to some embodiments of the present application;

FIG. 6 illustrates an exemplary BS's capability information transfer procedure according to some embodiments of the present application; and

FIG. 7 illustrates a simplified block diagram of an exemplary apparatus for RAT-dependent positioning integrity according to some embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order shown or in sequential order, or that among all illustrated operations to be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3GPP 5G (i.e., new radio (NR)), 3GPP long term evolution (LTE) Release 8 and so on. Persons skilled in the art know very well that, with the development of network architecture and new service scenarios, the embodiments in the present application are also applicable to similar technical problems; and moreover, the terminologies recited in the present application may change, which should not affect the principle of the present application.

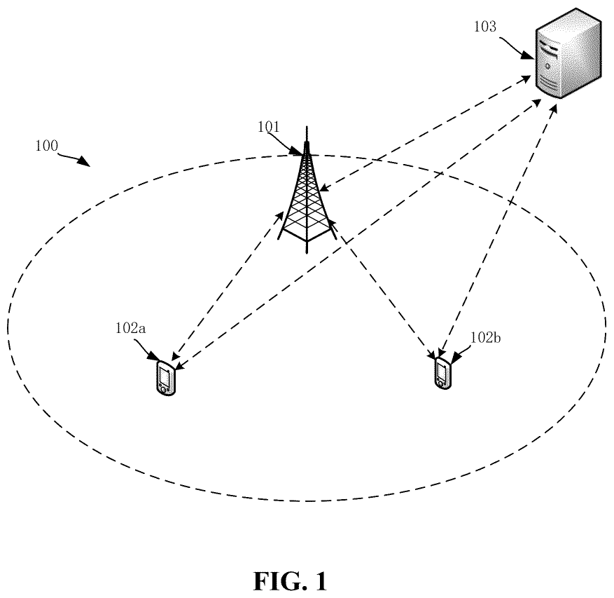

FIG. 1 is a schematic diagram illustrating an exemplary wireless communication system 100 according to some embodiments of the present application.

As shown in FIG. 1, the wireless communication system 100 includes at least one BS 101, at least one UE (e.g., a UE 102a and a UE 102b), and at least on LMF 103. Although one BS, two UEs, and one LMF are depicted in FIG. 1 for illustrative purpose, it is contemplated that any number of BSs, UEs, and LMFs may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

The BS 101 may also be referred to as an access point, an access terminal, a base, a macro cell, a radio access network (RAN) node, a next generation (NG) radio access network (RAN) node, a node-B, an enhanced node B (eNB), a gNB, a home node-B, a relay node, or a device, or described using other terminology used in the art. The BS 101 is generally part of a RAN that may include a controller communicably coupled to the BS 101.

According to some embodiments of the present application, the UE 102a and the UE 102b may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE. In an embodiment of the present application, the UE 102a may be a power-saving UE and the UE 102b may be a VUE. In another embodiment of the present application, both the UE 102a and the UE 102b may be VUEs or power-saving UEs.

According to some other embodiments of the present application, the UE 102a and the UE 102b may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE 102a and the UE 102b may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE 102a and the UE 102b may include wearable devices, such as smart watches, fitness bands, optical head-mounted displays, or the like.

Moreover, a UE may be referred to as a subscriber unit, a mobile, a mobile station, a user, a terminal, a mobile terminal, a wireless terminal, a fixed terminal, a subscriber station, a user terminal, or a device, or described using other terminology used in the art.

Both the UE 102a and the UE 102b in the embodiments of FIG. 1 are in a coverage area of the BS 101, and may transmit information or data to the BS 101 and receive control information or data from the BS 101, for example, via LTE or NR Uu interface.

The LMF 103 (also referred to as LMF entity) may refer to a network element or network entity for supporting location services, which may be deployed in a core network (CN) or in a RAN of the wireless communication system 100. The LMF 103 may communicate with the BS 101 via NR positioning protocol A (NRPPa) signaling, and may communicate with the UE 102a or UE 102 b via LTE positioning protocol (LPP) signaling.

When a location service request is initiated or occurs at a UE, the UE (referred to as target UE or LCS target UE) needs to know its own position. When the target UE is within a coverage area of a BS or network (i.e., in coverage), the target UE may get positioning information from the BS or LMF, which is known as Uu positioning or NR Uu positioning. The NR Uu positioning may include RAT-dependent positioning. The RAT-dependent positioning may mean that the UE's position is calculated based on reference signal (e.g., SRS, PRS, and/or other reference signal) measurement(s) in Uu interface.

Positioning accuracy and positioning integrity are related but separate concepts. For many use cases, positioning accuracy alone is insufficient to meet the requirements. Positioning devices and services are typically designed to report the distribution of errors that characterize the overall system performance, which is often specified as an error percentile representing the positioning accuracy. For example, a road vehicle with an embedded UE positioning client may report a lane-level accuracy is (<50 cm, 95%), which means that: based on all the computed positions, the estimated positioning accuracy is better than 50 cm, 95% of the time. However, for the remaining 5% of the time, the positioning errors are unknown. In fact, these positioning errors might reach tens or hundreds of meters due to multiple different error sources. The positioning errors in the remaining 5% of the time are essentially unbounded without any way to reliably validate their distribution. In the case of GNSS positioning, the error sources may include constellation geometry (i.e., dilution of precision), sharp atmospheric gradients or irregularities, and local receiver effects such as high measurement noise or multipath.

Positioning integrity refers to a measure of trust in an accuracy of the position-related data provide by a positioning system and an ability to provide timely and valid warnings to an LCS client when the positioning system does not fulfil a condition for an intended operation. For example, each time a position is provided, positioning integrity can be used to quantify the trust on the provided position. Therefore, positioning integrity may be a method of bounding the above positioning errors, which can be done by a much higher confidence. For example, a target integrity risk (TIR) of 10⁻⁷/hr translates to a 99.99999% probability that no hazardously misleading outputs occurred in a given hour of operation. That is, the TIR sets a target for determining which feared events need to be monitored in order to meet the specified alert limit (AL) at this level of probability. A lower TIR introduces a wider range of threats (e.g., feared events) that need to be monitored to improve confidence in the estimated position. Erroneous position estimates which do not meet the positioning integrity criteria can then be omitted in the final positioning solution, allowing only the valid position estimates to be utilized, which also leads to a higher accuracy.

The positioning integrity may at least include the following KPIs.
TIR: a probability that a positioning error exceeds an AL without warning a user within the required time-to-alert (TTA). In some embodiments, the TIR may be defined as a probability rate per a time unit. For example, the time unit may be an hour, a second, an independent sample, etc. In practice, the TIR is very small. For example, <10⁻⁷/hr TIR translates to one failure permitted every 10 million hours (which equivalent to 1142 years approximately).
AL: a maximum allowable positioning error such that a positioning system is available for an intended application. If the positioning error is beyond the AL, the positioning system should be declared unavailable for the intended application to prevent loss of positioning integrity. In some embodiments, when the AL bounds the positioning error in the horizontal plane or on the vertical axis, it is called horizontal alert limit (HAL) or vertical alert limit (VAL), respectively.
TTA: a maximum allowable elapsed time from when the positioning error exceeds the AL until a function providing positioning integrity annunciates a corresponding alert.
Integrity Availability: a percentage of time that a protection level (PL) is below the required AL.

Generally, the PL is a real-time upper bound on the positioning error at the required degree of confidence, where the degree of confidence is determined by the TIR probability. For example, the PL may be defined as follows.

The PL is a statistical upper-bound of the positioning error (PE) that ensures that, the probability per unit of time of the true error being greater than the AL and the PL being less than or equal to the AL, for longer than the TTA, is less than the required TIR, i.e., the PL satisfies the following inequality:
Probability per unit of time [((PE>AL) & (PL<=AL)) for longer than TTA]<required TIR

The PL is used to indicate the positioning system availability. When the PL is greater than the AL, the system is considered unavailable. The PL establishes a more rigorous upper bound on the positioning error by taking into consideration the additional feared events which have a lower occurrence (e.g., a lower TIR) compared to the nominal events considered in the standard accuracy estimate alone. The lower the TIR is, the more feared events need to be considered.

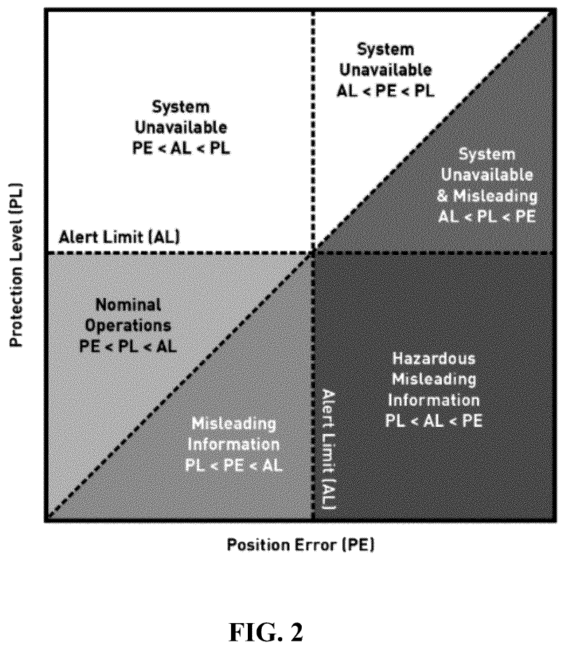

FIG. 2 illustrates exemplary relationships between the PL and KPIs for positioning integrity according to some embodiments of the present application.

Referring to FIG. 2, the positioning system may perform nominal operations when PE<PL<AL. The positioning system may be considered as unavailable when PE<AL<PL or AL<PE<PL. The positioning system may be considered as unavailable and misleading when AL<PL<PE.

In addition, FIG. 2 also illustrates two cases that hazardous misleading information (HMI) and misleading information (MI) are respectively output.

Specifically, positioning integrity system failures are known as integrity events, which occur when the positioning system outputs HMI. HMI may be output when the positioning system is declared available while the actual positioning error exceeds the AL without annunciating an alert within the required TTA (i.e., PL<AL<PE as shown in FIG. 2).

Moreover, MI is output when the positioning system is declared available while the actual positioning error exceeds the PL (i.e., PL<PE<AL). Typically, positioning systems are designed to tolerate some level of MI, provided that the system can continue to operate safely within the AL. To properly monitor integrity in the positioning system, both the fault and fault-free conditions which potentially lead to MI or HMI need to be characterized for the network and the UE.

The concepts of positioning integrity have already been introduced and supported for GNSS positioning in 3GPP Rel-17. However, there is no study on integrity support for RAT-dependent positioning. In order to support the RAT-dependent positioning integrity, some technical problems need to be addressed.

For example, one technical problem is related to the capability transfer for RAT-dependent positioning integrity. Specifically, capability transfer is the first step for supporting RAT-dependent positioning integrity. During the capability transfer procedure, the capability request signaling and capability response signaling should be supported, and a UE may acknowledge in the capability response signaling whether it has a capability to access integrity assistance information and KPIs or not. In some embodiments of the present application, the capability transfer is handled separately per positioning method.

For GNSS positioning integrity, LPP messages such as RequestCapabilities and ProvideCapabilities may be used to transfer capability information regarding whether GNSS positioning integrity is supported. Considering that RAT-dependent positioning integrity may reuse the concepts and principles being developed for GNSS positioning integrity, LPP signaling to support capability transfer of RAT-dependent positioning integrity may be used as baseline. However, different from GNSS positioning integrity in which only a UE and an LMF transfer the integrity related information, RAT-dependent positioning may involve three entities, i.e., UE, RAN node (e.g., a BS) and LMF, and each entity may generate error sources and/or feared events which may affect the integrity performance. Given this, each entity should be aware of the RAT-dependent positioning integrity capability, and thus the capability transfer procedure for GNSS positioning integrity should be enhanced.

Another technical problem is related to integrity information monitoring and reporting for RAT-dependent positioning.

Specifically, for RAT-dependent positioning, error sources affecting measurements may come from the network, the signal propagation, and the UE itself. In order to quantify the positioning integrity risk of the positioning solution and its error bound, the UE or network (NW) needs to support integrity monitoring for RAT-dependent positioning under different integrity modes.

For example, the following table 1 illustrates two exemplary integrity modes, wherein each integrity mode includes several scenarios for integrity monitoring and reporting.

TABLE 1
Potential scenarios for integrity monitoring and reporting

| | | | | | | Integrity |
|---|---|---|---|---|---|---|
| | | | Source of | Source of | Destination | procedure |
| Integrity | LCS | Integrity | integrity | integrity | of integrity | signaling |
| mode | type | monitoring | info | results | results | impact |
| UE-based | MO-LR | UE- | UE | UE | UE | N/A |
| integrity | | monitoring | | | | |
| mode | | NW- | BS/LMF | UE | UE | NW->UE: |
| | | monitoring | | | | Monitor info |
| | MT-LR | UE- | UE | UE | LMF | UE->LMF: |
| | | monitoring | | | | Integrity results |
| | | NW- | BS/LMF | UE | LMF | NW->UE: |
| | | monitoring | | | | Monitor info |
| | | | | | | UE->LMF: |
| | | | | | | Integrity results |
| NW-based | MO-LR | UE- | UE | LMF | UE | UE->NW: |
| integrity | | monitoring | | | | Monitor info |
| mode | | | | | | LMF->UE: |
| | | | | | | Integrity results |
| | | NW- | BS/LMF | LMF | UE | LMF->UE: |
| | | monitoring | | | | Integrity results |
| | MT-LR | UE- | UE | LMF | LMF | UE->NW: |
| | | monitoring | | | | Monitor info |
| | | NW- | BS/LMF | LMF | LMF | N/A |
| | | monitoring | | | | |

Monitor info: monitored information related to RAT-dependent positioning integrity from UE or NW side.
Integrity results: calculated integrity results (e.g., PL) from UE side (UE-based integrity mode) or NW side (NW-based integrity mode).

Referring to table 1, the two exemplary integrity modes may include a UE-based integrity mode and an NW-based integrity mode. The UE-based integrity mode may refer to that the integrity results are calculated by the UE (i.e., the source of integrity results is the UE), while the NW-based integrity mode may refer to that the integrity results are calculated by the NW (i.e., the source of integrity results is the LMF).

In the UE-based integrity mode, depending on whether the location request (LR) is originated by the UE or the network, the LCS type may be a mobile originated LR (MO-LR) type or a mobile terminated LR (MT-LR) type. With an MO-LR, a UE may send a request to a serving public land mobile network (PLMN) for location related information for the UE; with an MT-LR, an LCS client or application functions (AFs) external to or internal to a serving PLMN may send a location request to the serving PLMN for the location of a target UE.

For the MO-LR type of the UE-based integrity mode, the integrity information may be monitored by the UE (i.e., the source of integrity information is the UE) or by the NW (i.e., the source of integrity information is the BS or the LMF). In order that the UE may calculate the integrity results based on the integrity information, in the case that the integrity information is monitored by the NW, the NW needs to transmit the monitored integrity information to the UE. Since the LR is originated by the UE, the destination of the integrity results is the UE and the UE does not need to transfer the calculated integrity results.

For the MT-LR type of the UE-based integrity mode, the NW also needs to transmit the monitored integrity information to the UE in the case that the integrity information is monitored by the NW. In addition, since the LR is originated by the LMF, the destination of the integrity results is the LMF and the UE needs to transmit the calculated integrity results to the LMF.

Similarly, in the NW-based integrity mode, depending on whether the LR is originated by the UE or the network, the LCS type may be an MO-LR type or an MT-LR type. With an MO-LR, a UE may send a request to a serving PLMN for location related information for the UE; with an MT-LR, an LCS client or AFs external to or internal to a serving PLMN may send a location request to the serving PLMN for the location of a target UE.

For the MO-LR type of the NW-based integrity mode, the integrity information may be monitored by the UE (i.e., the source of integrity information is the UE) or by the NW (i.e., the source of integrity information is the BS or the LMF). In order that the LMF may calculate the integrity results based on the integrity information, in the case that the integrity information is monitored by the UE, the UE needs to transmit the monitored integrity information to the LMF. Since the LR is originated by the UE, the destination of the integrity results is the UE and the LMF needs to transmit the calculated integrity results to the UE.

For the MT-LR type of the NW-based integrity mode, the UE also needs to transmit the monitored integrity information to the LMF in the case that the integrity information is monitored by the UE. In addition, since the LR is originated by the network, the destination of the integrity results is the LMF and the LMF does not need to transfer the calculated integrity results to the UE.

It is obvious from table 1 that related procedure and corresponding signaling impact on RAT-dependent integrity in some scenarios needs to be specified.

For example, in the NW-monitoring scenario, a network entity (e.g., BS or LMF) may detect the integrity risk for RAT-dependent positioning solution and report the detected risk to a UE in the UE-based integrity mode to help the UE to calculate the positioning integrity results or output an alarm in certain conditions. In such scenario, the content of the monitored integrity information, the reported integrity information, corresponding transmission conditions, and associated signaling impact should be defined.

In another example, in the UE-monitoring scenario or a NW-monitoring scenario, a UE or a BS may detect the integrity risk for RAT-dependent positioning solution and report the detected risk to an LMF in the NW-based integrity mode to help the LMF to calculate the positioning integrity results or output an alarm in certain conditions. In such scenario, the content of the monitored integrity information, the reported integrity information, corresponding transmission conditions, and associated signaling impact should also be defined.

Given the above, embodiments of the present application propose solutions for RAT-dependent positioning integrity, which can solve at least one of the above technical problems. For example, some embodiments of the present application propose solutions regarding the capability transfer among the UE, the BS, and the LMF. In addition, some embodiments of the present application propose solutions regarding the contents of the RAT-dependent positioning integrity information and the signaling procedure for transmitting the RAT-dependent positioning integrity information in different scenarios. More details on embodiments of the present application will be described in the following text in combination with the appended drawings.

According to some embodiments of the present application, in order to support RAT-dependent positioning integrity, besides capability transfer procedure between the UE and the LMF, the BS also needs to acquire the UE's capability information for RAT-dependent positioning integrity. In addition, the BS also needs to transfer its own capability information for RAT-dependent positioning integrity to the LMF or the UE.

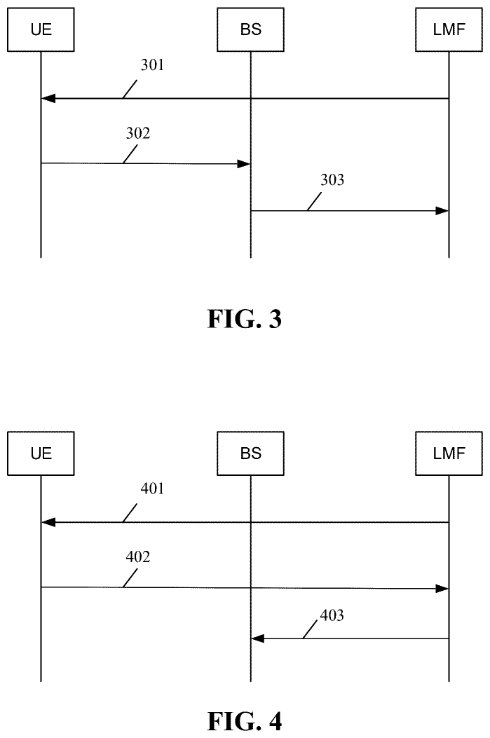

FIG. 3 illustrates an exemplary UE's capability information transfer procedure according to some embodiments of the present application.

Referring to FIG. 3, in step 301, an LMF may transmit a request message (e.g., an LPP message RequestCapabilities as specified in 3GPP standard documents) to a UE. The request message may request the UE's capability information for RAT dependent positioning integrity. The request message may indicate the UE to transmit the capability information to a BS.

After receiving the request message, in step 302, the UE may transmit the capability information to the BS, e.g., via a radio resource control (RRC) message.

In some embodiments of FIG. 3, the UE may support one or more RAT-dependent positioning methods, which may include at least one of: an enhanced cell identity (ECID) positioning method, a time difference of arrival (TDOA) positioning method, a round trip time (RTT) positioning method, etc. The UE's capability information for RAT dependent positioning integrity may include one or more sets of information, wherein each set of information is associated with one of the one or more RAT-dependent positioning methods and includes at least one of:
an indication indicating whether the UE has a RAT-dependent integrity capability for the associated RAT-dependent positioning method; or
an integrity level (e.g., a high integrity, a medium integrity, a low integrity, no integrity, etc.) for the associated RAT-dependent positioning method supported by the UE.

After receiving the capability information from the UE, in step 303, the BS may transmit the received capability information to the LMF, e.g., via an NRPPa message.

FIG. 4 illustrates another exemplary UE's capability information transfer procedure according to some embodiments of the present application.

Referring to FIG. 4, in step 401, an LMF may transmit a request message (e.g., an LPP message RequestCapabilities as specified in 3GPP standard documents) to a UE. The request message may request the UE's capability information for RAT dependent positioning integrity.

After receiving the request message, in step 402, the UE may transmit a response message (e.g., an LPP message ProvideCapabilities as specified in 3GPP standard documents). The response message may include the UE's capability information for RAT dependent positioning integrity, which may include the same content as that in the capability information described with respect to FIG. 3.

After receiving the capability information from the UE, in step 403, the LMF may transmit the received capability information to a BS, e.g., via an NRPPa message.

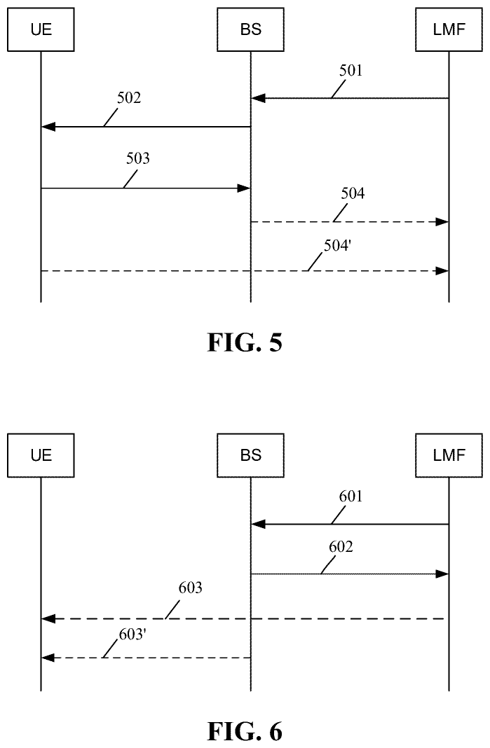

FIG. 5 illustrates yet another exemplary UE's capability information transfer procedure according to some embodiments of the present application.

Referring to FIG. 5, in step 501, an LMF may transmit a first request message (e.g., an NRPPa message) to a BS. The first request message may request capability information for RAT dependent positioning integrity of a UE.

After receiving the first request message, in step 502, the BS may transmit a second request message (e.g., an RRC message) to request the capability information for RAT dependent positioning integrity to the UE.

After receiving the second request message, in step 503, the UE may transmit a first response message (e.g., an RRC message) to the BS. The first response message may include the UE's capability information for RAT dependent positioning integrity, which may include the same content as that in the capability information described with respect to FIG. 3.

After receiving the capability information from the UE, in step 504, the BS may transmit a second response message (e.g., an NRPPa message) to the LMF, where the second response message may include the received capability information. In some other embodiments, in addition to transmitting the first response message to the BS, in step 504′, the UE may directly transmit its capability information to the LMF, e.g., via an LPP message.

Based on the method as illustrated in any of FIGS. 3-5, the BS and the LMF may acquire the UE's capability information for RAT dependent positioning integrity.

FIG. 6 illustrates an exemplary BS's capability information transfer procedure according to some embodiments of the present application.

Referring to FIG. 6, in step 601, an LMF may transmit a request message (e.g., an NRPPa message) to a BS. The request message may request the BS's capability information for RAT dependent positioning integrity.

After receiving the request message, in step 602, the BS may transmit a response message (e.g., an NRPPa message) to the LMF. The response message may include the BS's capability information for RAT dependent positioning integrity.

In some embodiments of FIG. 6, the BS may support one or more RAT-dependent positioning methods, which may include at least one of: an ECID positioning method, a TDOA positioning method, an RTT positioning method, etc. The BS's capability information for RAT dependent positioning integrity may include one or more sets of information, wherein each set of information is associated with one of the one or more RAT-dependent positioning methods and includes at least one of:
an indication indicating whether the BS has a RAT-dependent integrity capability for the associated RAT-dependent positioning method; or
an integrity level (e.g., a high integrity, a medium integrity, a low integrity, no integrity, etc.) for the associated RAT-dependent positioning method supported by the BS.

After receiving the capability information from the BS, in step 603, the LMF may transmit the received capability information to a UE, e.g., via an LPP message. In some other embodiments, in addition to transmitting the response message to the LMF, in step 603′, the BS may directly transmit its capability information to the UE, e.g., via an RRC message.

Based on the method as illustrated in FIG. 6, the UE and the LMF may acquire the BS's capability information for RAT dependent positioning integrity.

According to some embodiments of the present application, the network (e.g., a BS or LMF) or a UE may monitor RAT-dependent positioning integrity information, and then the monitored RAT-dependent positioning integrity information may be transmitted to an entity (for example, the entity may be a UE in the UE-based integrity mode or may be an LMF in the NW-based integrity mode) to help it to calculate the RAT-dependent positioning integrity results or output an alarm in certain conditions.

In some embodiments of the present application, before monitoring RAT-dependent positioning integrity information, integrity KPI(s) may be acquired for a UE, a BS and an LMF. For example, in the MO-LR scenario, the UE may transmit at least one integrity KPI to the BS and to the LMF. In another example, in the MT-LR scenario, the LMF may transmit at least one integrity KPI to the BS and to the UE. In an embodiment, the at least one integrity KPI may include at least one of: TIR, AL, TTA, etc.

As stated above, in some scenarios of the UE-based integrity mode, the network entity (e.g., at least one of the LMF or the BS) may monitor RAT-dependent positioning integrity information and transmit the RAT-dependent positioning integrity information to the UE.

Specifically, according to some embodiments of the present application, the LMF may monitor (or detect) error sources and/or integrity feared events. From the LMF side, the factors affecting positioning results may include uplink SRS measurement results received from transmit-receive points (TRPs), and feared events of assistance data for RAT-dependent positioning generated by the LMF itself. Based on the error sources and/or integrity feared events, the LMF may transmit RAT-dependent positioning integrity information to the UE.

The RAT-dependent positioning integrity information transmitted from the LMF to the UE may include at least one of: RAT-dependent positioning integrity assistance information, severity level(s) of detected integrity feared event(s), integrity result(s), or an integrity alert.

In some embodiments of the present application, the RAT-dependent positioning integrity assistance information transmitted from the LMF to the UE may include at least one of:
An integrity service parameter indicating a range of IRs for which RAT-dependent positioning assistance data is valid. In an embodiment, the RAT-dependent positioning assistance data may include information which may help the UE to obtain (or calculate) positioning results and/or integrity results. For example, the RAT-dependent positioning assistance data may include physical cell ID, TRP IDs of candidate TRPs for measurements, PRS configuration, etc. In an embodiment, the RAT-dependent positioning assistance data for each positioning method may be different.
RAT-dependent positioning assistance data with a quality indicator (or a quality flag). In an embodiment, the quality indicator may be marked for the RAT-dependent positioning assistance data each time the RAT-dependent positioning assistance data is provided from the LMF to the UE. For example, the quality indicator may be a “do not use (DNU)” flag indicating that the RAT-dependent positioning assistance data is not suitable for the purpose of computing integrity.
SRS measurement result(s) with a quality indicator (or a quality flag). In an embodiment, the SRS measurement result(s) may be received from one or more TRPs. After receiving the SRS measurement result(s), the LMF may mark a quality indicator for the SRS measurement result(s), and then transmit the marked SRS measurement result(s) to the UE.

In an embodiment, the RAT-dependent positioning integrity assistance information may be transmitted periodically from the LMF to the UE. The periodicity for transmitting the RAT-dependent positioning integrity assistance information may be implemented by the LMF.

In some embodiments of the present application, the LMF may detect integrity feared event(s) and evaluate severity level(s) of the integrity feared event(s). For example, for each integrity feared event, the LMF may evaluate a corresponding severity level. In an embodiment, a severity level may be defined as one of high, medium, low, etc. Alternatively or additionally, the LMF may detect integrity feared event(s) and calculate integrity result(s) (e.g., PL, integrity availability, etc.).

The integrity feared events in the embodiments of the subject application are considered to be all possible events (e.g., natural, man-made, systemic or operational nature) that can cause the computed position to deviate from the true position, regardless of whether a specific fault can be identified in one of the positioning systems or not.

Consequently, in the above embodiments, the LMF may transmit at least one of the severity level(s) of the detected integrity feared event(s) or the integrity result(s) to the UE. In an embodiment, the LMF may transmit the integrity result(s) to the UE in response to that the integrity result(s) reaches (reach) a pre-defined threshold.

In an embodiment, the at least one of the severity level(s) of the integrity feared event(s) or the integrity result(s) may be transmitted from the LMF to the UE periodically. The periodicity for transmitting the at least one of the severity level(s) of the integrity feared event(s) or the integrity result(s) may be implemented by the LMF.

In some embodiments of the present application, the LMF may transmit an integrity alert to the UE in response to that detected integrity information is within a predefined threshold range. In an embodiment, the detected integrity information may include at least one of but not limited to: integrity event persistence (or integrity event frequency), SRS measurement error, etc.

According to some other embodiments of the present application, the BS may monitor (or detect) error sources and/or integrity feared events. From the BS side, the factors affecting positioning results may include uplink SRS measurements for RAT-dependent positioning, and feared events of assistance data for RAT-dependent positioning provided by the LMF. Based on the error sources and/or integrity feared events, the BS may transmit RAT-dependent positioning integrity information to the UE.

The RAT-dependent positioning integrity information transmitted from the BS to the UE may also include at least one of: RAT-dependent positioning integrity assistance information, severity level(s) of detected integrity feared event(s), integrity result(s), or an integrity alert.

In some embodiments of the present application, the RAT-dependent positioning integrity assistance information transmitted from the BS to the UE may include SRS measurement result(s) with a quality indicator (or a quality flag). In an embodiment, the quality indicator may be marked for the SRS measurement result(s) each time the SRS measurement result(s) is (are) generated from BS side. For example, the quality indicator may be a “DNU” flag indicating that the SRS measurement result(s) is (are) not suitable for the purpose of computing integrity.

In an embodiment, the RAT-dependent positioning integrity assistance information may be transmitted to the UE via an LMF. For example, the RAT-dependent positioning integrity assistance information may be transmitted to an LMF firstly, and then transmitted from the LMF to the UE.

In another embodiment, the RAT-dependent positioning integrity assistance information may be transmitted to the UE directly.

In some cases, the BS may transmit the RAT-dependent positioning integrity assistance information to the UE or to the LMF once the BS generates the SRS measurement result(s).

In some other cases, the BS may transmit the RAT-dependent positioning integrity assistance information to the UE or to the LMF in response to the SRS measurement result(s) reaches (reach) a pre-defined threshold.

In some other cases, the RAT-dependent positioning integrity assistance information may be transmitted periodically from the BS to the UE or to the LMF. The periodicity for transmitting the RAT-dependent positioning integrity assistance information may be configured by the LMF or implemented by the BS.

In some embodiments of the present application, the BS may detect integrity feared event(s) and evaluate severity level(s) of the integrity feared event(s). For example, for each integrity feared event, the BS may evaluate a corresponding severity level. In an embodiment, a severity level may be defined as one of high, medium, low, etc. Alternatively or additionally, the BS may detect integrity feared event(s) and calculates integrity result(s) (e.g., PL, integrity availability, etc.).

Consequently, in the above embodiments, the BS may transmit at least one of the severity level(s) of the detected integrity feared event(s) or the integrity result(s) to the UE. In an embodiment, the BS may transmit the integrity result(s) to the UE in response to that the integrity result(s) reaches (reach) a pre-defined threshold.

In an embodiment, the at least one of the severity level(s) of the integrity feared event(s) or the integrity result(s) may be transmitted from the BS to the UE periodically. The periodicity for transmitting the at least one of the severity level(s) of the integrity feared event(s) or the integrity result(s) may be configured by the LMF or implemented by the BS.

In some embodiments of the present application, the BS may transmit an integrity alert to the UE in response to that detected integrity information is within a predefined threshold range. In an embodiment, the detected integrity information may include at least one of but not limited to: integrity event persistence (or integrity event frequency), SRS measurement error, etc.

The above embodiments describe monitoring and transmitting RAT-dependent positioning integrity information in the UE-based integrity mode. In some scenarios of the NW-based integrity mode, a UE or a BS may monitor RAT-dependent positioning integrity information and transmit the RAT-dependent positioning integrity information to the LMF.

Specifically, according to some embodiments of the present application, the UE may monitor (or detect) error sources and/or integrity feared events. From the UE side, the factors affecting positioning results may include downlink PRS measurements, feared events of assistance data for RAT-dependent positioning provided by the LMF, and/or feared events from the UE itself (e.g., hardware faults/software faults of the UE). Based on the error sources and/or integrity feared events, the UE may transmit RAT-dependent positioning integrity information to the LMF.

The RAT-dependent positioning integrity information transmitted from the UE to the LMF may include at least one of: RAT-dependent positioning integrity assistance information, severity level(s) of detected integrity feared event(s), integrity result(s), or an integrity alert.

In some embodiments of the present application, the RAT-dependent positioning integrity assistance information transmitted from the UE to the LMF may include at least one of:
An integrity service parameter indicating a range of IRs for which RAT-dependent positioning assistance data is valid. In an embodiment, the RAT-dependent positioning assistance data may include information which may help the UE to obtain (or calculate) positioning results and/or integrity results. For example, the RAT-dependent positioning assistance data may include physical cell ID, TRP IDs of candidate TRPs for measurements, PRS configuration, etc. In an embodiment, the RAT-dependent positioning assistance data for each positioning method may be different.
PRS measurement result(s) with a quality indicator (or a quality flag). In an embodiment, the quality indicator may be marked for the PRS measurement result(s) each time the PRS measurement result(s) is provided from the UE to the LMF. For example, the quality indicator may be a “DNU” flag indicating that the PRS measurement result(s) for RAT-dependent positioning is (are) not suitable for the purpose of computing integrity.
Information related to the UE. For example, the information related to the UE may include at least one of: an UE type of the UE, a velocity of the UE, an interference of the UE (e.g., received signal strength indicator (RSSI) or total interference plus noise), etc.

In an embodiment, the RAT-dependent positioning integrity assistance information may be transmitted periodically from the UE to the LMF. The periodicity for transmitting the RAT-dependent positioning integrity assistance information may be configured by the LMF or BS or pre-configured to the UE.

In some embodiments of the present application, the UE may detect integrity feared event(s) and evaluate severity level(s) of the integrity feared event(s). For example, for each integrity feared event, the UE may evaluate a corresponding severity level. In an embodiment, a severity level may be defined as one of high, medium, low, etc. Alternatively or additionally, the UE may detect integrity feared event(s) and calculates integrity result(s) (e.g., PL, integrity availability, etc.).

Consequently, in the above embodiments, the UE may transmit at least one of the severity level(s) of the detected integrity feared event(s) or the integrity result(s) to the LMF. In an embodiment, the UE may transmit the integrity result(s) to the LMF in response to that the integrity result(s) reaches (reach) a pre-defined threshold.

In an embodiment, the at least one of the severity level(s) of the integrity feared event(s) or the integrity result(s) may be transmitted from the UE to the LMF periodically. The periodicity for transmitting the at least one of the severity level(s) of the integrity feared event(s) or the integrity result(s) may be configured by the LMF or BS or pre-configured to the UE.

In some embodiments of the present application, the UE may transmit an integrity alert to the LMF in response to that detected integrity information is within a predefined threshold range. In an embodiment, the detected integrity information may include at least one of but not limited to: integrity event persistence (or integrity event frequency), PRS measurement error, etc.

According to some other embodiments of the present application, the BS may monitor (or detect) error sources and/or integrity feared events. From the BS side, the factors affecting positioning results may include uplink SRS measurements for RAT-dependent positioning, and feared events of assistance data for RAT-dependent positioning provided by the LMF. Based on the error sources and/or integrity feared events, the BS may transmit RAT-dependent positioning integrity information to the LMF.

The RAT-dependent positioning integrity information transmitted from the BS to the LMF may also include at least one of: RAT-dependent positioning integrity assistance information, severity level(s) of detected integrity feared event(s), integrity result(s), or an integrity alert.

In some embodiments of the present application, the RAT-dependent positioning integrity assistance information transmitted from the BS to the LMF may include SRS measurement result(s) with a quality indicator (or a quality flag). In an embodiment, the quality indicator may be marked for the SRS measurement result(s) each time the SRS measurement result(s) is (are) generated from BS side. For example, the quality indicator may be a “DNU” flag indicating that the SRS measurement result(s) is (are) not suitable for the purpose of computing integrity.

In some cases, the BS may transmit the RAT-dependent positioning integrity assistance information to the LMF once the BS generates the SRS measurement result(s).

In some other cases, the BS may transmit the RAT-dependent positioning integrity assistance information to the LMF in response to the SRS measurement result(s) reaches (reach) a pre-defined threshold.

In some other cases, the RAT-dependent positioning integrity assistance information may be transmitted periodically from the BS to the LMF. The periodicity for transmitting the RAT-dependent positioning integrity assistance information may be configured by the LMF or implemented by the BS.

In some embodiments of the present application, the BS may detect integrity feared event(s) and evaluate severity level(s) of the integrity feared event(s). For example, for each integrity feared event, the BS may evaluate a corresponding severity level. In an embodiment, a severity level may be defined as one of high, medium, low, etc. Alternatively or additionally, the BS may detect integrity feared event(s) and calculates integrity result(s) (e.g., PL, integrity availability, etc.).

Consequently, in the above embodiments, the BS may transmit at least one of the severity level(s) of the detected integrity feared event(s) or the integrity result(s) to the LMF. In an embodiment, the BS may transmit the integrity result(s) to the LMF in response to that the integrity result(s) reaches (reach) a pre-defined threshold.

In an embodiment, the at least one of the severity level(s) of the integrity feared event(s) or the integrity result(s) may be transmitted from the BS to the LMF periodically. The periodicity for transmitting the at least one of the severity level(s) of the integrity feared event(s) or the integrity result(s) may be configured by the LMF or implemented by the BS.

In some embodiments of the present application, the BS may transmit an integrity alert to the LMF in response to that detected integrity information is within a predefined threshold range. In an embodiment, the detected integrity information may include at least one of but not limited to: integrity event persistence (or integrity event frequency), SRS measurement error, etc.

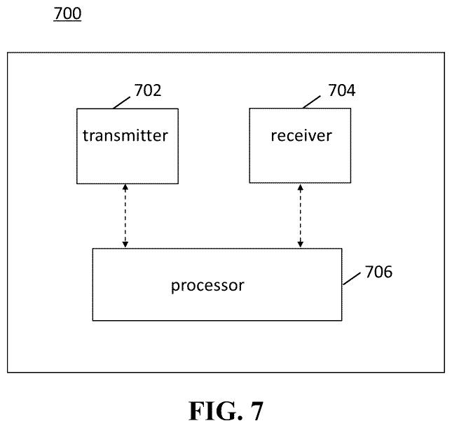

FIG. 7 illustrates a simplified block diagram of an exemplary apparatus 700 for RAT-dependent positioning integrity according to some embodiments of the present application. In some embodiments, the apparatus 700 may be or include at least part of an anchor UE. In some other embodiments, the apparatus 700 may be or include at least part of a target UE.

Referring to FIG. 7, the apparatus 700 may include at least one transmitter 702, at least one receiver 704, and at least one processor 706. The at least one transmitter 702 is coupled to the at least one processor 706, and the at least one receiver 704 is coupled to the at least one processor 706.

Although in this figure, elements such as the transmitter 702, the receiver 704, and the processor 706 are illustrated in the singular, the plural is contemplated unless a limitation to the singular is explicitly stated. In some embodiments of the present application, the transmitter 702 and the receiver 704 may be combined to one device, such as a transceiver. In some embodiments of the present application, the apparatus 700 may further include an input device, a memory, and/or other components. The transmitter 702, the receiver 704, and the processor 706 may be configured to perform any of the methods described herein (e.g., the methods described with respect to FIGS. 3-6 and other methods described in the embodiments of the present application).

According to some embodiments of the present application, the apparatus 700 may be a UE, and the transmitter 702, the receiver 704, and the processor 706 may be configured to perform operations of the UE in any of the methods as described with respect to FIGS. 3-6 and other methods described in the embodiments of the present application. For example, the receiver 704 is configured to receive a request message to request first capability information for RAT-dependent positioning integrity from a BS or an LMF. The transmitter 702 is configured to transmit a response message including the first capability information to the BS or the LMF.

According to some embodiments of the present application, the apparatus 700 may be a BS (e.g., an NG-RAN node), and the transmitter 702, the receiver 704, and the processor 706 may be configured to perform operations of the BS in any of the methods as described with respect to FIGS. 3-6 and other methods described in the embodiments of the present application. For example, the receiver 704 is configured to receive a request message to request first capability information for RAT-dependent positioning integrity from an LMF. The transmitter 702 is configured to transmit a response message including the first capability information to the LMF.

According to some embodiments of the present application, the apparatus 700 may be a network entity (e.g., an LMF), and the transmitter 702, the receiver 704, and the processor 706 may be configured to perform operations of the network entity in any of the methods as described with respect to FIGS. 3-6 and other methods described in the embodiments of the present application. For example, the transmitter 702 is configured to transmit a request message to request first capability information for RAT-dependent positioning integrity to a UE or a BS. The receiver 704 is configured to receive a response message including the first capability information from the UE or the BS.

In some embodiments of the present application, the apparatus 700 may further include at least one non-transitory computer-readable medium. In some embodiments of the present disclosure, the non-transitory computer-readable medium may have stored thereon computer-executable instructions to cause the processor 706 to implement any of the methods as described above. For example, the computer-executable instructions, when executed, may cause the processor 706 to interact with the transmitter 702 and/or the receiver 704, so as to perform operations of the methods, e.g., as described with respect to FIGS. 3-6 and other methods described in the embodiments of the present application.

The method according to any of the embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for RAT-dependent positioning integrity, including a processor and a memory. Computer programmable instructions for implementing a method for RAT-dependent positioning integrity are stored in the memory, and the processor is configured to perform the computer programmable instructions to implement the method for RAT-dependent positioning integrity. The method for RAT-dependent positioning integrity may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for RAT-dependent positioning integrity according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE) for wireless communication, comprising:
at least one memory; and
at least one processor coupled with the at least one memory and configured to cause the UE to:
receive a request message to request first capability information for radio access technology (RAT) dependent positioning integrity from a base station (BS) or a location management function (LMF); and
transmit a response message including the first capability information to the BS or the LMF.

2. The UE of claim 1, wherein the first capability information includes one or more sets of information, wherein each set of information is associated with a RAT-dependent positioning method and includes at least one of:
an indication indicating whether the UE has a RAT-dependent integrity capability for the RAT-dependent positioning method; or
an integrity level for the RAT-dependent positioning method supported by the UE.

3. The UE of claim 1, wherein the at least one processor is further configured to cause the UE to receive second capability information for RAT-dependent positioning integrity from the LMF, wherein the second capability information includes one or more sets of information, wherein each set of information of the one or more sets of information is associated with a RAT-dependent positioning method and includes at least one of:
an indication indicating whether the BS has a RAT-dependent integrity capability for the RAT-dependent positioning method; or
an integrity level for the RAT-dependent positioning method supported by the BS.

4. The UE of claim 1, wherein the at least one processor is further configured to cause the UE to receive, from the LMF, RAT-dependent positioning integrity assistance information including least one of:
RAT-dependent positioning assistance data with a quality indicator;
an integrity service parameter indicating a range of integrity risks (IRs) for which the RAT-dependent positioning assistance data is valid; or
sounding reference signal (SRS) measurement results with a quality indicator.

5. The UE of claim 1, wherein the at least one processor is further configured to cause the UE to receive, from the BS, RAT-dependent positioning integrity assistance information including SRS measurement results with a quality indicator.

6. The UE of claim 1, wherein the at least one processor is further configured to cause the UE to receive, from the BS or the LMF, at least one of:
severity levels of detected integrity feared events;
integrity results; or
an integrity alert.

7. The UE of claim 1, wherein the at least one processor is further configured to cause the UE to transmit, to the LMF, RAT-dependent positioning integrity assistance information including at least one of:
an integrity service parameter indicating a range of IRs for which RAT-dependent positioning assistance data is valid;
positioning reference signal (PRS) measurement results with a quality indicator; or
information related to the UE.

8. The UE of claim 1, wherein the at least one processor is further configured to cause the UE to:
detect integrity feared events;
evaluate severity levels of the integrity feared events or calculate integrity results; and
transmit, to the LMF, at least one of the severity levels of the integrity feared events or the integrity results.

9. A base station (BS) for wireless communication, comprising:
at least one memory; and
at least one processor coupled with the at least one memory and configured to cause the BS to:
receive a request message to request first capability information for radio access technology (RAT) dependent positioning integrity from a location management function (LMF); and
transmit a response message including the first capability information to the LMF; and
wherein the first capability information includes one or more sets of information, wherein each set of information of the one or more sets of information is associated with a RAT-dependent positioning method and includes at least one of:
an indication indicating whether the BS has a RAT-dependent integrity capability for the RAT-dependent positioning method; or
an integrity level for the RAT-dependent positioning method supported by the BS.

10. The BS of claim 9, wherein the at least one processor is further configured to cause the BS to receive second capability information for RAT-dependent positioning integrity, wherein the second capability information includes one or more sets of information, wherein each set of information is associated with a RAT-dependent positioning method and includes at least one of:
an indication indicating whether a user equipment (UE) has a RAT-dependent integrity capability for the RAT-dependent positioning method; or
an integrity level for the RAT-dependent positioning method supported by the UE.

11. The BS of claim 10, wherein the second capability information is received from the UE, and the at least one processor is further configured to cause the BS to transmit the second capability information to the LMF.

12. The BS of claim 11, wherein the at least one processor is further configured to cause the BS to receive a first request message to request the second capability information from the LMF, and the transmitter is further configured to transmit a second request message to request the second capability information to the UE.

13. The BS of claim 10, wherein the at least one processor is further configured to cause the BS to transmit RAT-dependent positioning integrity assistance information to the UE or to the LMF, wherein the RAT-dependent positioning integrity assistance information includes sounding reference signal (SRS) measurement results with a quality indicator.

14. The BS of claim 10, wherein the at least one processor is further configured to cause the BS to:
detect integrity feared events;
evaluate severity levels of the integrity feared events or calculate integrity results; and
transmit, to the UE or to the LMF, at least one of the severity levels of the integrity feared events or the integrity results.

15. A network entity, comprising:
at least one memory; and
at least one processor coupled with the at least one memory and configured to cause the network entity to:
transmit a request message to request first capability information for radio access technology (RAT) dependent positioning integrity to a user equipment (UE) or a base station (BS); and
receive a response message including the first capability information from the UE or the BS.

16. The network entity of claim 15, wherein the at least one processor is further configured to cause the network entity to transmit, to the UE, RAT-dependent positioning integrity assistance information including least one of: RAT-dependent positioning assistance data with a quality indicator; an integrity service parameter indicating a range of integrity risks (IRs) for which the RAT-dependent positioning assistance data is valid; or sounding reference signal (SRS) measurement results with a quality indicator

17. A processor for wireless communication, comprising:
at least one controller coupled with at least one memory and configured to cause the processor to:
receive a request message to request first capability information for radio access technology (RAT) dependent positioning integrity from a base station (BS) or a location management function (LMF); and
transmit a response message including the first capability information to the BS or the LMF.

18. The processor of claim 17, wherein the at least one controller is further configured to cause the processor to receive, from the LMF, RAT-dependent positioning integrity assistance information including least one of:
RAT-dependent positioning assistance data with a quality indicator;
an integrity service parameter indicating a range of integrity risks (IRs) for which the RAT-dependent positioning assistance data is valid; or
sounding reference signal (SRS) measurement results with a quality indicator.

19. The processor of claim 17, wherein the at least one controller is further configured to cause the processor to receive, from the BS or the LMF, at least one of:
severity levels of detected integrity feared events;
integrity results; or
an integrity alert.

20. The processor of claim 17, wherein the first capability information includes one or more sets of information, wherein each set of information is associated with a RAT-dependent positioning method and includes at least one of:
an indication indicating whether the processor has a RAT-dependent integrity capability for the RAT-dependent positioning method; or
an integrity level for the RAT-dependent positioning method supported by the processor.
